(19) United States
(12) Patent Application Publication
(10) Pub. No.: US 2007/0007385 A1
(43) Pub. Date: Jan. 11, 2007

(54) Electric flight control surface actuation system electronic architecture

(75) Inventors: Calvin C. Potter, Mesa, AZ (US); Casey Hanlon, Queen Creek, AZ (US); Paul T. Wingett, Mesa, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/192,817

(22) Filed: Jul. 29, 2005

Related U.S. Application Data
(60) Provisional application No. 60/694,641, filed on Jun. 27, 2005.

(51) Int. Cl. B64D 33/00

(52) U.S. Cl. 244/53 R

(57) ABSTRACT

An electric flight control surface actuation system is implemented using a low level control section and a high power section. The low level control section is disposed within an electronics bay within the aircraft, and is in operable communication with one or more flight computers via a communication bus. The flight computers supply flight control surface position commands to the low level control section, which in turn transmits actuator commands to the high power section via a plurality of redundant communication links. The high power section is disposed remotely from the low level control section and, in addition to being in operable communication with the low level control section, is coupled to an aircraft power bus and to each of the actuators. The high power section receives the actuator position commands transmitted from the low level control section and, in response, selectively energizes the actuators from the aircraft power bus.

### CROSS-REFERENCES TO RELATED APPLICATIONS

This application claims the benefit of U.S. Provisional Application No. 60/694,641, filed Jun. 27, 2005.

### TECHNICAL FIELD

The present invention relates to flight surface actuation and, more particularly, to the electrical architecture for an electric flight control surface actuation system.

### BACKGROUND

Aircraft typically include a plurality of flight control surfaces that, when controllably positioned, guide the movement of the aircraft from one destination to another. The number and type of flight control surfaces included in an aircraft may vary, but typically include both primary flight control surfaces and secondary flight control surfaces. The primary flight control surfaces are those that are used to control aircraft movement in the pitch, yaw, and roll axes, and the secondary flight control surfaces are those that are used to influence the lift or drag (or both) of the aircraft. Although some aircraft may include additional control surfaces, the primary flight control surfaces typically include a pair of elevators, a rudder, and a pair of ailerons, and the secondary flight control surfaces typically include a plurality of flaps, slats, and spoilers.

The positions of the aircraft flight control surfaces are typically controlled using a flight control surface actuation system. The flight control surface actuation system, in response to position commands that originate from either the flight crew or an aircraft autopilot, moves the aircraft flight control surfaces to the commanded positions. In most instances, this movement is effected via actuators that are coupled to the flight control surfaces. Though unlikely, it is postulated that a flight control surface actuator could become inoperable. Thus, some flight control surface actuation systems are implemented with a plurality of actuators coupled to a single flight control surface.

In many flight control surface actuation systems, some of the actuators are hydraulically powered. Some flight control surface actuation systems have been implemented, however, with other types of actuators, including pneumatic and electromechanical actuators. Additionally, in some flight control surface actuation systems, a portion of the actuators, such as those that are used to drive the flaps and slats, are driven via one or more central drive units and mechanical drive trains. These central drive units are typically hydraulically powered devices.

Although the flight control surface actuation systems that include hydraulically powered or pneumatically powered actuators are generally safe, reliable, and robust, these systems do suffer certain drawbacks. Namely, these systems can be relatively complex, can involve the use of numerous parts, can be relatively heavy, and may not be easily implemented to provide sufficient redundancy, fault isolation, and/or system monitoring.

The flight control surface actuation systems that include electromechanical actuators also suffer certain drawbacks. For example, many of these systems are implemented such that independent control and power wiring is individually routed to each electromechanical actuator, which can increase overall system complexity and weight.

Hence, there is a need for a flight control surface actuation system that is less complex and/or uses less parts and/or is lighter than systems that use central drive units and/or provides sufficient redundancy, fault isolation, and monitoring. The present invention addresses one or more of these needs.

### BRIEF SUMMARY

The present invention provides a flight control surface actuation system that is less complex and/or uses less parts and/or is lighter than systems that use central drive units and/or provides sufficient redundancy, fault isolation, and monitoring.

In one embodiment, and by way of example only, a flight control surface actuation system includes an actuator motor, a flight control surface actuator, an actuator control circuit, and a motor power circuit. The actuator motor is configured, upon being energized, to supply a drive force. The flight control surface actuator is coupled to receive the drive force and is operable, upon receipt thereof, to move between stowed and deployed positions. The actuator control circuit is adapted to be disposed remote from the actuator motor and the flight surface actuator, is adapted to receive flight surface position commands, and is operable, in response to the flight surface position commands, to transmit actuator position commands. The motor power circuit is adapted to be disposed remote from, and is in operable communication with, the actuator control circuit and is adapted to couple to an aircraft power bus, the motor power circuit is additionally configured to receive the transmitted actuator position commands and, upon receipt thereof, to selectively energize the actuator motor from the aircraft power bus.

In another exemplary embodiment, a flight control surface actuation system includes a plurality of motors, a plurality of flight control surface actuators, a plurality of actuator control circuits, and a plurality of motor power circuits. Each motor is configured, upon being energized, to supply a drive force. Each flight control surface actuator is coupled to receive the drive force from at least one of the actuator motors and is operable, upon receipt of the drive force, to move between stowed and deployed positions. Each actuator control circuit is adapted to be disposed remote from the actuator motors and the flight control surface actuators, is adapted to receive flight control surface position commands, and is operable, in response thereto, to transmit actuator position commands. Each motor power circuit is adapted to be disposed remote from, and is in operable communication with, at least one of the actuator control circuits and is adapted to couple to an aircraft power bus, each motor power circuit is additionally configured to receive transmitted actuator position commands and, upon receipt thereof, to selectively energize at least one of the actuator motors from the aircraft power bus.

Other independent features and advantages of the preferred electric flight control surface actuation system will become apparent from the following detailed description, taken in conjunction with the accompanying drawings which illustrate, by way of example, the principles of the invention.

### BRIEF DESCRIPTION OF THE DRAWINGS

FIG. 1 is a schematic diagram of a portion of an exemplary embodiment of an aircraft depicting an embodiment of a portion of an exemplary flight control surface actuation system;

FIG. 2 is a schematic diagram of an exemplary power and control system that may be used in the exemplary flight control surface actuation system that is partially shown in FIG. 1; and

FIG. 3 is a schematic diagram of an alternative power and control system that may be used in the exemplary flight control surface actuation system that is partially shown in FIG. 1

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

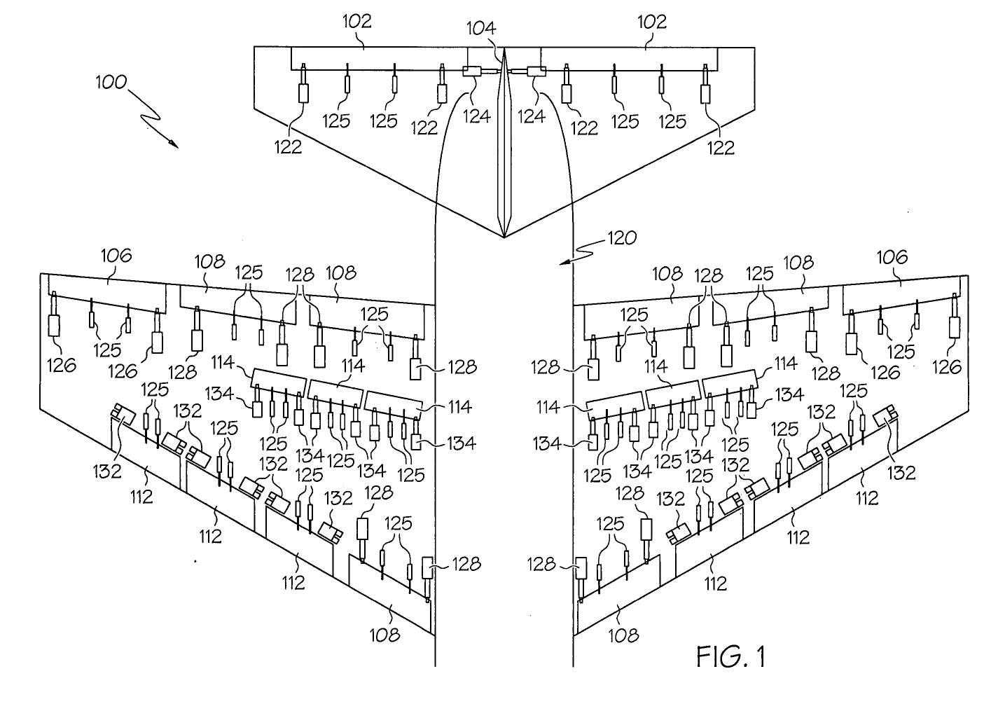

Turning first to FIG. 1, a schematic diagram of a portion of an exemplary aircraft and a portion of an exemplary flight control surface actuation system is shown. In the illustrated embodiment, the aircraft 100 includes a pair of elevators 102, a rudder 104, and a pair of ailerons 106, which are the primary flight control surfaces, and a plurality of flaps 108, slats 112, and spoilers 114, which are the secondary flight control surfaces. The primary flight control surfaces 102-106 control aircraft movements about the aircraft pitch, yaw, and roll axes. Specifically, the elevators 102 are used to control aircraft movement about the pitch axis, the rudder 104 is used to control aircraft movement about the yaw axis, and the ailerons 106 control aircraft movement about the roll axis. It is noted, however, that aircraft movement about the yaw axis can also be achieved either by banking the aircraft or by varying the thrust levels from the engines on opposing sides of the aircraft 100. It will additionally be appreciated that the aircraft 100 could include horizontal stabilizers (not shown).

The secondary control surfaces 108-114 influence the lift and drag of the aircraft 100. For example, during aircraft take-off and landing operations, when increased lift is desirable, the flaps 108 and slats 112 may be moved from retracted positions to extended positions. In the extended position, the flaps 108 increase both lift and drag, and enable the aircraft 100 to descend more steeply for a given airspeed, and also enable the aircraft 100 get airborne over a shorter distance. The slats 112, in the extended position, increase lift, and are typically used in conjunction with the flaps 108. The spoilers 114, on the other hand, reduce lift and when moved from retracted positions to extended positions, which is typically done during aircraft landing operations, may be used as air brakes to assist in slowing the aircraft 100.

The flight control surfaces 102-114 are moved between retracted and extended positions via a flight control surface actuation system 120. The flight control surface actuation system 120 includes a plurality of primary flight control surface actuators, which include elevator actuators 122, rudder actuators 124, and aileron actuators 126, and a plurality of secondary control surface actuators, which include flap actuators 128, slat actuators 132, and spoiler actuators 134. The flight control surface actuation system 110 may be implemented using various numbers and types of flight control surface actuators 122-134. In addition, the number and type of flight control surface actuators 122-134 per flight control surface 102-114 may be varied. In the depicted embodiment, however, the system 120 is implemented such that two primary flight control surface actuators 122-126 are coupled to each primary flight control surface 102-16, and two secondary control surface actuators 128-134 are coupled to each secondary control surface 108-114. Moreover, each of the primary surface actuators 122-126 and each of the flap actuators 128 are preferably a linear-type actuator, such as, for example, a ballscrew actuator, and each of the slat actuators 132 and each of the spoiler actuators 134 are preferably a rotary-type actuator. It will be appreciated that this number and type of flight control surface actuators 122-134 are merely exemplary of a particular embodiment, and that other numbers and types of actuators 122-134 could also be used.

The flight control surface actuation system 120 additionally includes a plurality of control surface position sensors 125. The control surface position sensors 125sense the positions of the flight control surfaces 102-114 and supply control surface position feedback signals representative thereof. It will be appreciated that the control surface position sensors 125may be implemented using any one of numerous types of sensors including, for example, linear variable differential transformers (LVDTs), rotary variable differential transformers (RVDTs), Hall effect sensors, or potentiometers, just to name a few. In the depicted embodiment, a pair of control surface position sensors 125 is coupled to each of the flight control surfaces 102-114. It will be appreciated, however, that this is merely exemplary of a particular embodiment and that more or less than two position sensors 125 could be coupled to each flight control surface 102-114. Moreover, in other embodiments, the flight control surface actuation system 120 could be implemented without some, or all, of the control surface position sensors 125.

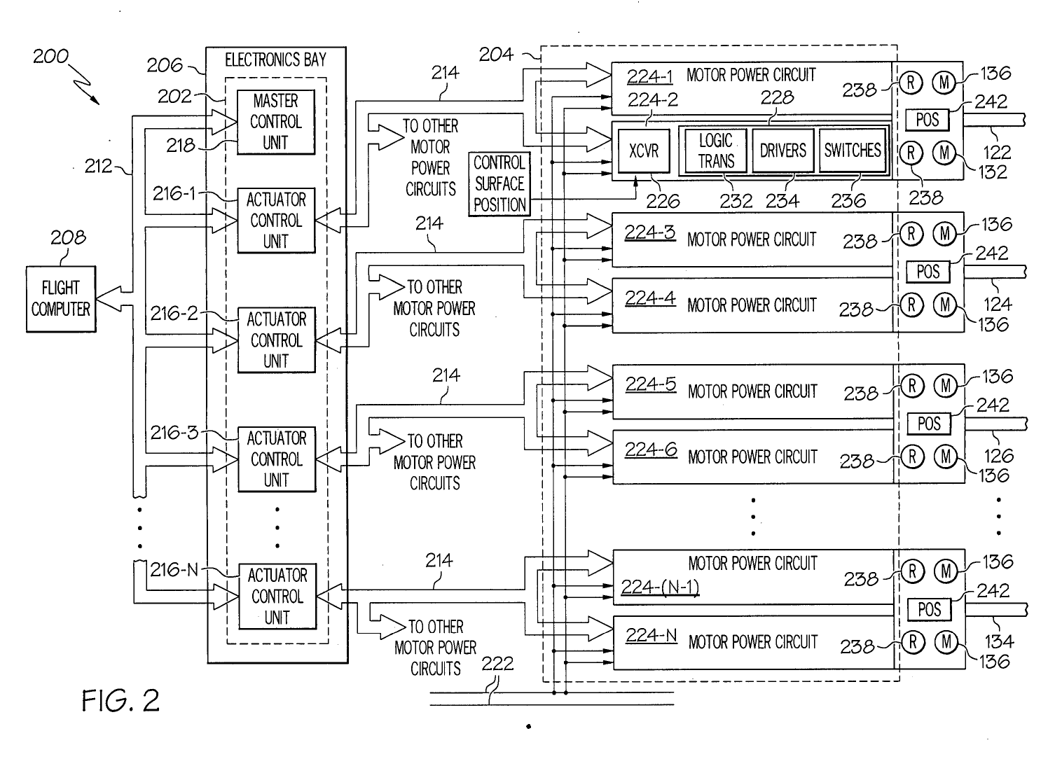

The flight control surface actuators 122-134 are each driven by one or more electric actuator motors 136. Preferably, two actuator motors 136 (see FIG. 2) are associated with each flight control surface actuator 122-134 such that either, or both, actuator motors 136 can drive the associated actuator 122-134. The actuator motors 136 are selectively energized and, upon being energized, rotate in one direction or another, to thereby supply a drive force to the associated actuator 122-134. The actuators 122-134 are each coupled to receive the drive force supplied from its associated actuator motors 136 and, depending on the direction in which the actuator motors 136 rotate, move between stowed and deployed positions, to thereby move the primary and secondary flight control surfaces 102-114. It will be appreciated that the actuator motors 136 may be implemented as any one of numerous types of AC or DC motors, but in a preferred embodiment the actuator motors 136 are preferably implemented as DC motors.

The actuator motors 136 are selectively energized from one of a plurality of independent power busses that form part of the aircraft electrical power distribution system. For example, many aircraft electrical power distribution systems include a plurality of 28 VDC busses that distribute DC power to various systems and components. The actuator motors 136 are selectively energized from one of these independent power busses via a power and control system 200. The architecture of the power and control system 200 is shown in FIG. 2, and with reference thereto will now be described in more detail.

The power and control system 200 includes a low level control section 202 and a high power section 204. The low level control section 202 is preferably disposed within an electronics bay 206 within the aircraft, and is in operable communication with one or more flight computers 208 (only one shown) via, for example, a communication bus 212. The flight computers 208 receive commands, either from the pilot or an autopilot, and, in response, supply flight control surface position commands to the low level control section 202. In response to the flight control surface position commands, the low level control section 202 transmits actuator commands to the high power section 204 via a plurality of redundant communication links 214.

To implement the above-described functionality, the low level control section 202 includes a plurality of redundant actuator control circuits 216 (216-1, 216-2, 216-3, . . . 216-N) that are preferably physically separate from one another. For example, in the depicted embodiment, each actuator control circuit 216 is implemented as a separate circuit card. The actuator control circuits 216 are each coupled to receive flight control surface position commands from the flight computer 208 via, for example, the communication bus 212. The actuator control circuits 216, in response to the flight control surface position commands, supply actuator position commands.

The actuator position commands that each actuator control circuit 216 supplies will depend, for example, on the particular control law being implemented. The particular control law (or control laws) that an actuator control circuit 216 is implementing may vary depending, for example, on the particular flight control surface (or surfaces) 102-114 that the actuator control circuit 216 is controlling. For example, the control law used to implement position control of an elevator 102 may differ from that used to implement position control of the rudder 104. It will be appreciated that the actuator control circuits 216 may be implemented using analog circuit components, programmable logic devices, one or more processors, or various combinations of these or other circuit elements. It will additionally be appreciated that the control law(s) that a particular actuator control circuit 216 implements may be hardware based or embedded or otherwise stored in a local memory.

In addition to supplying actuator position commands, each actuator control circuit 216 is also configured to supply a status signal representative of its health. The status signal from each actuator control circuit 216 is communicated, via the communication bus 212, to the flight computer 208, based on the status signals, determines the operability of each of the actuator control circuits 216. The status signals may also be communicated, via the communication bus 212, to each of the other actuation control circuits 216, or to a master control unit 218 (if included), or to both the master control unit 218 and each of the other actuation control circuits 216.

The master control unit 218, if included, is in operable communication, via the communication bus 212 or a separate communication bus, with the flight computer 208 and each of the actuator control circuits 216. The master control unit 218, among other functions, supplies configuration commands to each of the actuator control circuits 216. The configuration commands supplied to a particular actuator control circuit 216 include data representative of the specific control law (or control laws) that the particular actuator control circuit 216 should implement. The actuator control circuit 216, upon receipt of the configuration command, configures itself to implement the specific control law (or laws).

As was noted above, the flight computer 208, based on the status signals supplied from the actuation control circuits 216, determines the operability of each of the actuator control circuits 216. If the flight computer 208 determines that an actuation control circuit 216 is inoperable, the flight control computer 208 may, if needed, supply a reconfiguration request to the master control unit 218. The master control unit 218, in response to the reconfiguration request, supplies configuration commands to one of the remaining operable actuator control circuits 216. Depending on the format of the configuration commands, the actuator control circuit 216 to which the configuration command was transmitted, will implement the control laws of the inoperable actuator control circuit 216, in addition to, or instead of, the control laws it normally implements.

In an alternate embodiment, the flight computer 208 is configured to supply commands to the actuator control circuits 216 that will cause the actuator control circuits to implement additional, or different, control laws. In this alternative embodiment, the master control unit 218 provides, for example, an acknowledge signal to the flight computer 208. It will additionally be appreciated that the low level control section 202, in yet another alternative embodiment, could be implemented without the master control unit 218.

The high power section 204 is disposed remotely from the low level control section 202, and is in operable communication with the low level control section 202 via the redundant communication links 214. The high power section is additionally coupled to one or more aircraft power busses 222 (only one shown in FIG. 2) and to each of the actuator motors 136. The high power section 204 receives the actuator position commands transmitted from the low level control section 202. In response to the actuator position commands, the high power section 204 selectively energizes the actuator motors 136 from the aircraft power bus 222.

To implement the above-described functionality, the high power section 204 includes a plurality of redundant motor power circuits 224 (224-1, 224-2, 224-3, . . . 224-N). The motor power circuits 224 are configured such that two motor power circuits 224 are associated with each actuator 122-134. Moreover, each motor power circuit 224 is configured such that a single motor power circuit 224 can selectively energize one or both actuator motors 136 associated with its actuator 122-134. In a preferred embodiment, one motor power circuit 224 is active and is configured to selectively energize both actuator motors 136, and the other motor power circuit 224 is in an inactive, or standby mode. With this configuration, if the active motor power circuit 224 associated with an actuator 122-134 becomes inoperable, the inactive motor power circuit 224 is then activated and is used to selectively energize both actuator motors 136. It will be appreciated that this is merely exemplary, and in an alternative embodiment each motor power circuit 224 could be active and configured to selectively energize either one actuator motor 136 or both actuator motors 136. In this alternative embodiment, if one of the motor power circuits 224 associated with an actuator 122-134 becomes inoperable, the affected actuator 122-134 would be powered from a single actuator motor 136. Or, if a single motor power circuit 224 is configured to selectively energize two actuator motors 136, the remaining operable motor power circuit 224 will selectively energize both actuator motors 136.

It will additionally be appreciated that the motor power circuits 224 may be implemented using any one of numerous circuit configurations. In the depicted embodiment, however, the motor power circuits 224 each include a transceiver circuit 226 and a motor control circuit 228. For clarity, only one of the motor power circuits 224-1 is illustrated to show these circuits 226, 228, each of which be now be briefly described.

The transceiver circuit 226 receives actuator position commands from, and transmits feedback signals to, the low level control section 202, via the communication links 214. The transceiver circuit 226 may be implemented using any one of numerous types of circuits that implement both transmit and receive functions. The choice of transceiver circuit type may depend, for example, on the particular physical implementation of the communication links 214. As will be described further below, the communication links 214 may be implemented using any one of numerous types of wired, optical, or wireless communication links. Thus, the transceiver circuit 226 may be implemented, for example, as any one of numerous types of RF or IR transceiver circuits or as any one of numerous types of digital input/output (I/O) circuits. No matter the specific physical implementation, the transceiver circuit 226, upon receipt of the actuator position commands from the low level control section, suitably conditions and supplies the actuator position commands to the motor control circuit 228.

The motor control circuit 228 is coupled to the aircraft power bus 222 and to the transceiver circuit 226. The motor control circuit 228, upon receipt of the actuator position command s from the transceiver circuit 226, selectively energizes one of the actuator motors 136 from the aircraft power bus 222. The motor control circuit 228 may be implemented using any one of numerous circuit configurations to provide this functionality. In the depicted embodiment, however, the motor control circuit 228 includes suitable logic translation circuitry 232, drivers 234, and power switches 236.

The logic translation circuitry 232 translates the actuator position commands into appropriate logic level signals, which are in turn supplied to the drivers 234. The drivers 234, in response to the logic level signals, supply switch driver signals to appropriate ones of the power switches 236. The power switches 236 are electrically coupled between the aircraft power bus 222 and the actuator motor 136. The power switches 236, which may be, for example, high-power SCRs or other types of semiconductor power switches, selectively switch between conductive and non-conductive states in response to the switch driver signals, to thereby selectively energize the actuator motor 136 from the aircraft power bus 222.

As was noted above, the transceiver circuit 226 additionally transmits feedback signals to the low level control section 202. These feedback signals may vary, but in the depicted embodiment the feedback signals include a speed signal and one or more position signals. More specifically, the feedback signals include a motor position and speed signal, which is representative of the rotational position and speed of the actuator motor (or motors) 136, an actuator position signal, which is representative of actuator position, and a flight control surface position, which is representative of the position of the flight control surface 102-114 to which the associated actuator 122-134 is coupled.

Thus, as FIG. 2 additionally shows, each actuator motor 136 preferably includes a motor resolver unit 238, and each actuator 122-134 preferably includes an actuator position sensor 242. The motor resolver units 238 sense the rotational position and speed of the actuator motors 136 and supply the motor position and speed signals to the appropriate transceiver circuits 226. The actuator position sensors 242 sense the position of the actuators 122-134 and supply the actuator position signals to the appropriate transceiver circuits 226. Similarly, as is also shown in FIG. 2, the transceiver circuits 226 also receive actuator position signals from the appropriate control surface position sensors 125.

The transceiver circuits 226 transmit the motor position and speed signals, the actuator position signals, and the control surface position signals back to the low level control section 202, via the communication links 214. The appropriate actuator control circuit 216 in the low level control section 202 uses these feedback signals to, for example, provide appropriate actuator motor 136 synchronization, so that the actuators 122-134 coupled to the same control surface 102-114 move at about the same rate. The actuator control circuits 216 also compare these feedback signals to the actual actuator commands and supply updated actuator commands, as needed, back to the high power section 204 via the communication links 214.

The redundant communication links 214 may be implemented using any one of numerous types of hard-wired, optical, or wireless high-speed communication links. Some non-limiting examples of suitable high-speed communication links include various types of wireless radio frequency (RF) communication links, various types of wireless infrared (IR), various types of fiber optic cables, or various types of hard-wired busses, such as, for example, standard 1553 type serial busses, just to name a few. As was noted above, the actuator control circuits 216 are configurable to implement one or more control laws. Thus, as FIG. 2 also shows, the communication links 214 are configured such that each actuator control circuit 216 can communicate with the transceiver circuits 226 associated with each of the flight control surface actuators 122-134.

During normal operation of the flight control surface actuation system 120, each actuator control circuit 216 implements a specific control law to thereby control one of the flight control surface actuators 122-134. If, however, one or more of the actuator control circuits 216, or one or more of the communication links 214, becomes inoperable, one or more of the actuator control circuits 216 can be reconfigured, as described above, to implement one or more additional or different control laws in addition to, or instead of, the control laws it normally implements, and supply actuator commands to each of the affected actuator 122-134. As such, the configuration of the low level control section 202 and communication links 214 provide the flight control surface actuation system 120 with a high level of system redundancy. Moreover, as was described above, the configuration of the high power section 204 also provides a high level of system redundancy.

In addition to the high level of redundancy, the configuration and implementation of the separately disposed low level control section 202 and high power section 204 makes the flight control surface actuation system 120 less susceptible to electronic noise. Moreover, because a system of high power cables is not coupled between the low level control section 202 and the high power section 204, significant weight and cost benefits can be realized.

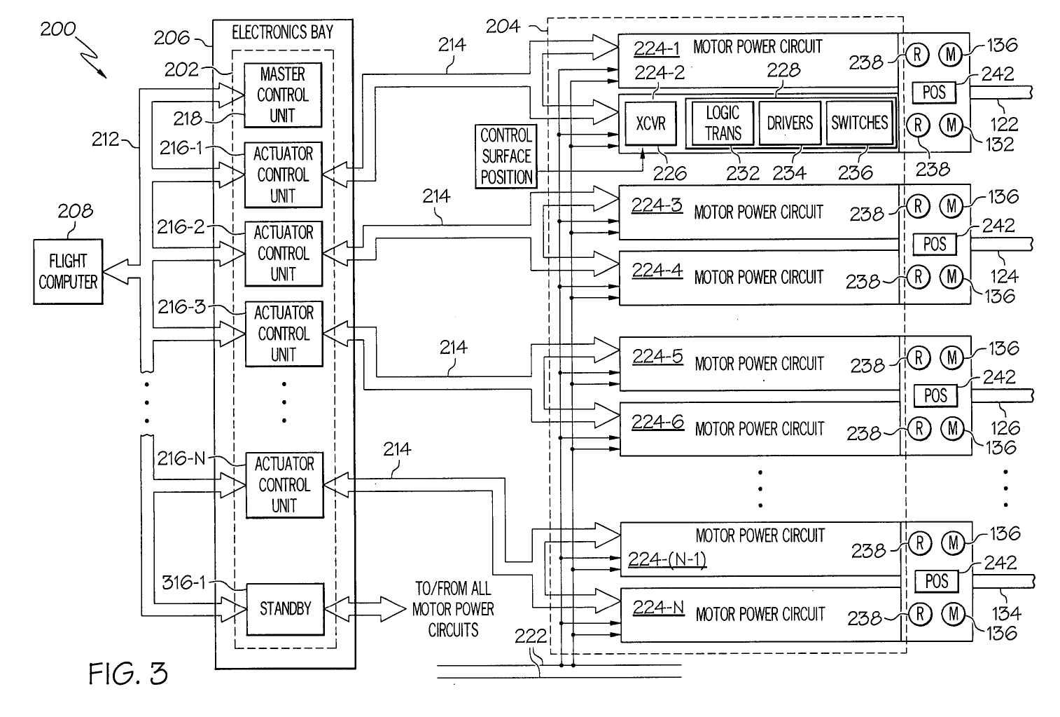

It will be appreciated that the configuration depicted in FIG. 2 and described above is merely exemplary, and that various other configurations can be implemented. For example, as FIG. 3 shows, the system 120 can be configured such that each actuator control circuit 216 is not configurable to communicate with each motor power circuit 224. Rather, with this configuration, each actuator control circuit 216 is in operable communication, via a single communication link 214, with only two motor power circuits 224. With this configuration, system redundancy in the low level control section 202 is provided via one or more standby actuator control circuits 316. For clarity, FIG. 3 shows only one standby actuator control circuit 316, though it will be appreciated that the low level control section 202 could be implemented with a plurality of standby actuator control circuits 316.

The standby actuator control circuit 316, unlike the other actuator control circuits 216, is coupled to each of the motor power circuits 224 via a communication link 214. However, like the actuator control circuits 216 described in the previous embodiment, the actuator control circuit 316 is configurable to implement one or more control laws. With this embodiment, if one or more of the normally-active actuator control circuits 216, or one or more of the communication links 214, becomes inoperable, the standby actuator control circuit 316 can be configured to implement one or more control laws, and supply actuator commands to each of the affected actuator 122-134.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A flight control surface actuation system, comprising:
an actuator motor configured, upon being energized, to supply a drive force;
a flight control surface actuator coupled to receive the drive force and operable, upon receipt thereof, to move between stowed and deployed positions;
an actuator control circuit adapted to be disposed remote from the actuator motor and flight surface actuator, the actuator control circuit adapted to receive flight surface position commands and operable, in response thereto, to transmit actuator position commands; and
a motor power circuit in operable communication with, and adapted to be disposed remote from, the actuator control circuit, and adapted to couple to an aircraft power bus, the actuator motor power circuit configured to receive the transmitted actuator position commands and, upon receipt thereof, to selectively energize the actuator motor from the aircraft power bus.

2. The system of claim 1, wherein the motor power circuit comprises:
a transceiver circuit configured to receive the actuator position commands transmitted by the actuator control circuit;
a motor control circuit coupled to receive the actuator position commands received by the transceiver circuit and operable, in response thereto, to selectively energize the actuator motor from the aircraft power bus.

3. The system of claim 1, wherein the actuator control circuit is configured to communicate with one or more other actuator control circuits.

4. The system of claim 1, wherein the actuator control circuit is operable, upon receipt of the flight surface position commands, to implement one or more actuator control laws to thereby generate the actuator position commands.

5. The system of claim 4, wherein the actuator control circuit is further adapted to receive a configuration command, and is further operable, upon receipt thereof, to implement the one or more actuator control laws.

6. The system of claim 1, further comprising:
a rotational speed sensor operable to sense motor rotational speed and supply a rotational speed signal representative thereof,
wherein the motor power circuit is coupled to receive the rotational speed signal and is further operable to transmit the rotational speed signal to the actuator control circuit.

7. The system of claim 6, wherein the actuator control circuit is coupled to receive the rotational speed signal transmitted from the motor power circuit and is operable, in response thereto, to transmit updated actuator position commands.

8. The system of claim 1, further comprising:
an actuator position sensor operable to sense actuator position and supply an actuator position signal representative thereof,
wherein the motor power circuit is coupled to receive the actuator position signal and is further operable to transmit the actuator position signal to the actuator control circuit.

9. The system of claim 8, wherein the actuator control circuit is coupled to receive the actuator position signal transmitted from the motor power circuit and is operable, in response thereto, to transmit updated actuator position commands.

10. The system of claim 1, further comprising:
a control surface position sensor operable to sense flight control surface position and supply a control surface position signal representative thereof,
wherein the motor power circuit is coupled to receive the control surface position signal and is further operable to transmit the actuator position signals to the actuator control circuit.

11. The system of claim 10, wherein the actuator control circuit is coupled to receive the control surface position signal transmitted from the motor power circuit and is operable, in response thereto, to transmit updated actuator position commands.

12. The system of claim 1, wherein the actuator control circuit and the motor power circuit are in operable communication via a radio frequency (RF) communication link.

13. The system of claim 1, wherein the actuator control circuit and the motor power circuit are in operable communication via an infrared (IR) communication link.

14. The system of claim 1, wherein the actuator control circuit and the motor power circuit are in operable communication via a serial data link.

15. A flight control surface actuation system, comprising:
a plurality of motors, each motor configured, upon being energized, to supply a drive force;
a plurality of flight control surface actuators, each flight control surface actuator coupled to receive the drive force from at least one of the actuator motors and operable, upon receipt of the drive force, to move between stowed and deployed positions;
a plurality of actuator control circuits adapted to be disposed remote from the actuator motors and the flight control surface actuators, each actuator control circuit adapted to receive flight control surface position commands and operable, in response thereto, to transmit actuator position commands; and
a plurality of motor power circuits, each motor power circuit in operable communication with, and adapted to be disposed remote from, at least one of the actuator control circuits, and adapted to couple to an aircraft power bus, each motor power circuit configured to receive transmitted actuator position commands and, upon receipt thereof, to selectively energize at least one of the actuator motors from the aircraft power bus.

16. The system of claim 15, wherein each motor power circuit comprises:
a transceiver circuit configured to receive the transmitted actuator position commands; and
a motor control circuit coupled to receive the actuator position commands received by the transceiver circuit and operable, in response thereto, to selectively energize at least one of the actuator motors from the aircraft power bus.

17. The system of claim 15, wherein each of the actuator control circuit are in operable communication with each other.

18. The system of claim 15, wherein each actuator control circuit is operable, upon receipt of the flight surface position commands, to implement one or more actuator control laws to thereby generate the actuator position commands.

19. The system of claim 18, wherein each actuator control circuit is further adapted to receive a configuration command, and is further operable, upon receipt thereof, to implement the one or more actuator control laws.

20. The system of claim 19, further comprising:
a master control unit in operable communication with each of the actuator control circuits and configured to supply the configuration commands thereto.

21. The system of claim 20, wherein:
each actuator control circuit is further operable to supply a status signal representative of circuit health; and
the master control unit is coupled to receive each status signal and, in response thereto, supply the configuration commands.

22. The system of claim 15, further comprising:
a plurality of rotational speed sensors, each rotational speed sensor operable to sense the rotational speed of one of the motors and supply a rotational speed signal representative thereof,
wherein each motor power circuit is coupled to receive one or more of the rotational speed signals and is further operable to transmit the rotational speed signals to one or more of the actuator control circuits.

23. The system of claim 22, wherein each actuator control circuit is coupled to receive one or more of the rotational speed signals transmitted from the motor power circuits and is operable, in response thereto, to transmit updated actuator position commands.

24. The system of claim 15, further comprising:
a plurality of actuator position sensors, each actuator position sensor operable to sense actuator position and supply an actuator position signal representative thereof,
wherein each motor power circuit is coupled to receive one or more of the actuator position signals and is further operable to transmit the actuator position signals to one or more of the actuator control circuits.

25. The system of claim 24, wherein each actuator control circuit is coupled to receive one or more of the actuator position signals transmitted from the motor power circuits and is operable, in response thereto, to transmit updated actuator position commands.

26. The system of claim 15, further comprising:
a plurality of control surface position sensors, each control surface position sensor operable to sense flight control surface position and supply a control surface position signal representative thereof,
wherein the motor power circuit is coupled to receive the control surface position signals and is further operable to transmit the actuator position signals to the actuator control circuit.

27. The system of claim 26, wherein each actuator control circuit is coupled to receive one or more of the control surface position signals transmitted from the motor power circuits and is operable, in response thereto, to transmit updated actuator position commands.

28. The system of claim 15, wherein each actuator control circuit is in operable communication with one or more of the motor power circuits via a radio frequency (RF) communication link.

29. The system of claim 15, wherein each actuator control circuit is in operable communication with one or more of the motor power circuits via an infrared (IR) communication link.

30. The system of claim 15, wherein each actuator control circuit is in operable communication with one or more of the motor power circuits via a serial data link.

31. The system of claim 15, wherein:
the plurality of actuator control circuits include a plurality of normally-active actuator control circuits and a standby actuator control circuit;
each of the normally-active actuator control circuits is in operable communication with two motor power circuits; and
the standby actuator control circuit is in operable communication with each of the motor power circuits.
